(19) United States
(12) Patent Application Publication
(10) Pub. No.: US 2008/0061731 A1
(43) Pub. Date: Mar. 13, 2008

(54) Communication apparatus with a solar energy charging function

(76) Inventors: Kuo-Len Lin, Wugu Township (TW); Tien-Chih Tseng, Wugu Township (TW); Wen-Jung Liu, Wugu Township (TW); Hai-Rui Ye, Wugu Township (TW)

Correspondence Address: HDSL, 4331 STEVENS BATTLE LANE, FAIRFAX, VA, 22033, US

(21) Appl. No.: 11/530,106

(22) Filed: Sep. 8, 2006

(51) Int. Cl. H02J 7/00

(52) U.S. Cl. 320/101

(57) ABSTRACT

A communication apparatus with a solar energy charging function includes a main system and a display device movably and pivotally coupled to the main system to define a foldable mobile phone, and a solar panel is coaxially and pivotally coupled to a pivotal connecting position of the display device and the main system, such that the solar panel can be folded and covered onto an external distal surface of the display device. If the battery power of the mobile phone is low, users can lift the solar panel open from the display device to charge the battery that is electrically coupled to the mobile phone, so as to enhance the power capacity, using time limit and battery charging requirements of the communication apparatus.

### BACKGROUND OF THE INVENTION

1. Field of the Invention

The present invention relates to a communication apparatus with a solar energy charging function, and more particularly to a communication apparatus that installs a solar panel to a main system which is coaxially and pivotally connected to a display device of a foldable mobile phone for charging a battery anytime when the solar panel is opened from the display device, so as to facilitate users to charge the battery of the mobile phone and use the mobile phone for communications.

2. Description of Prior Art

At present, a communication apparatus such as a mobile phone and a personal digital assistant (PDA) having a communication function needs a battery for supplying power, but the battery generally comes with a battery capacity, and the idle time or communication time of the communication apparatus is limited by the battery capacity. However, users may not be able to charge a battery of a mobile phone from the utility power, automobile cigarette lighter plug or USB when the battery power is low, since it is inconvenient to carry a battery charger or a power cable. Users usually prepare a second backup battery or a third backup battery to change batteries and maintain the normal communication status of the communication apparatus, but it is still inconvenient to carry or change the backup batteries.

R.O.C. Pat. No. M285126 entitled “Solar energy mobile phone charger structure” discloses a multi-functional solar energy mobile phone charger that installs a solar panel for converting solar energy into electric energy that is supplied to a lamp, a mobile phone charger, a mosquito repeller, an alarm and an outdoor camping lamp and charges the battery by connecting a power cable to a mobile phone connected to the battery.

Further, R.O.C. Pat. No. 448600 entitled “Method and apparatus for charging a battery of a mobile phone by solar energy discloses that a solar energy charging apparatus is connected to a battery of a mobile phone, such that the charging apparatus supplies the working power to the mobile phone and uses the remaining electric power capacity to charge the battery.

Although the foregoing patented inventions disclose a way of charging or using a battery of a mobile phone by adopting solar energy as its primary energy sources and converting the solar energy into electric energy in order to charge or use the battery of the mobile phone, the solar energy charging structure still needs to install a charger. In other words, the solar energy charging design integrates a charger directly to a mobile phone instead of a communication apparatus, and thus users still need a solar energy charger and its power cable, which are still inconvenient to carry and use.

### SUMMARY OF THE INVENTION

In view of the foregoing shortcomings of the prior art, the inventor of the present invention based on years of experience in the related industry to conduct experiments and modifications, and finally designed a feasible solution to overcome the shortcomings of the prior art.

Therefore, it is a primary objective of the present invention to overcome the shortcomings of the prior art by providing a simple structure that adopts a hinge structure to pivotally connect a solar panel and a display device of a foldable mobile phone to a main system, and fold the solar panel onto a distal surface of the display device, such that the solar panel can be lifted open for conveniently and easily charging the battery installed in the mobile phone, and the electric power of the mobile phone can be supplied to the communication apparatus to enhance the carrying of the backup battery and the application of charging a battery in a mobile manner.

To achieve the foregoing objective, the communication apparatus with a solar energy charging function of the invention comprises:

a main system, having a hinge portion;

a display device, having a first pivotal shaft installed at an end of the display device;

a solar panel, having a second pivotal shaft installed at an end of the solar panel; and

an axle mechanism;

such that the solar panel comprised of a second pivotal shaft and a first pivotal shaft of a display device is coaxially and pivotally coupled to the hinge portion of the main system while an axle mechanism is movably and pivotally coupled to the hinge portion of the main system, and thus the solar panel can be folded and covered onto a distal surface of the display device or lifted open to absorb solar energy to be converted into electric energy for charging a battery that is electrically connected to a mobile phone.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a lifted open state in accordance with a preferred embodiment of the present invention;

FIG. 2 is a side view of a lifted open state in accordance with a preferred embodiment of the present invention;

FIG. 3 is a schematic view of a folded close state in accordance with a preferred embodiment of the present invention;

FIG. 4 is a side view of a lifted open state for the use in accordance with a preferred embodiment of the present invention;

FIG. 5 is a perspective view of a lifted open state for the use in accordance with a preferred embodiment of the present invention;

FIG. 6 is a perspective view of a folded state in accordance with another preferred embodiment of the present invention; and

FIG. 7 is a perspective view of a lifted open state for the use in accordance with another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

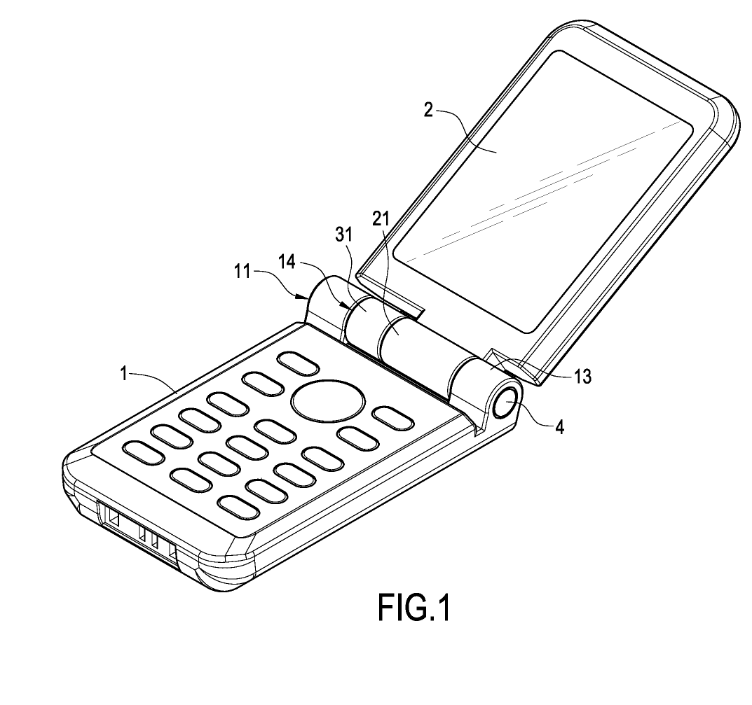

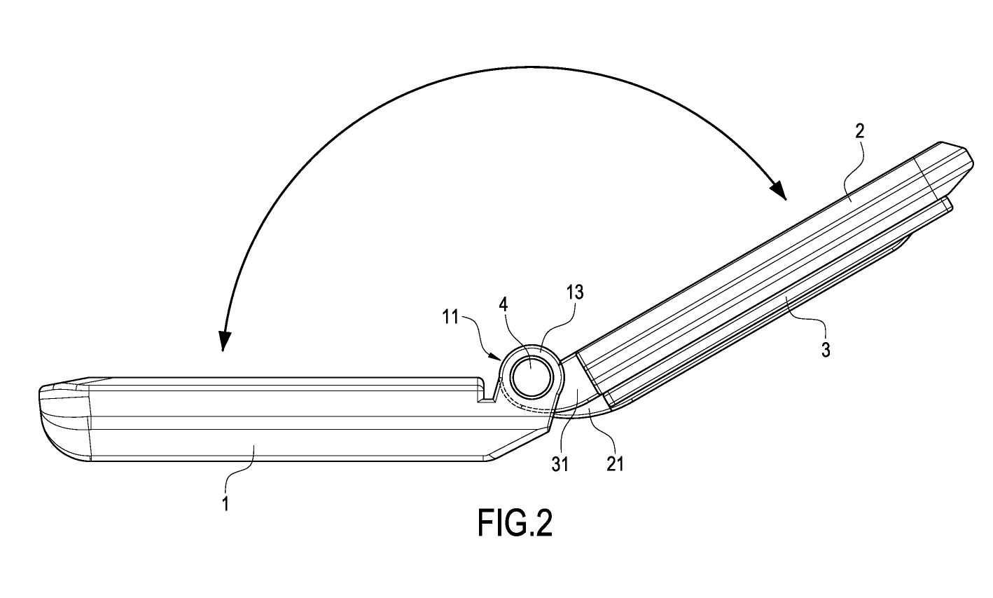

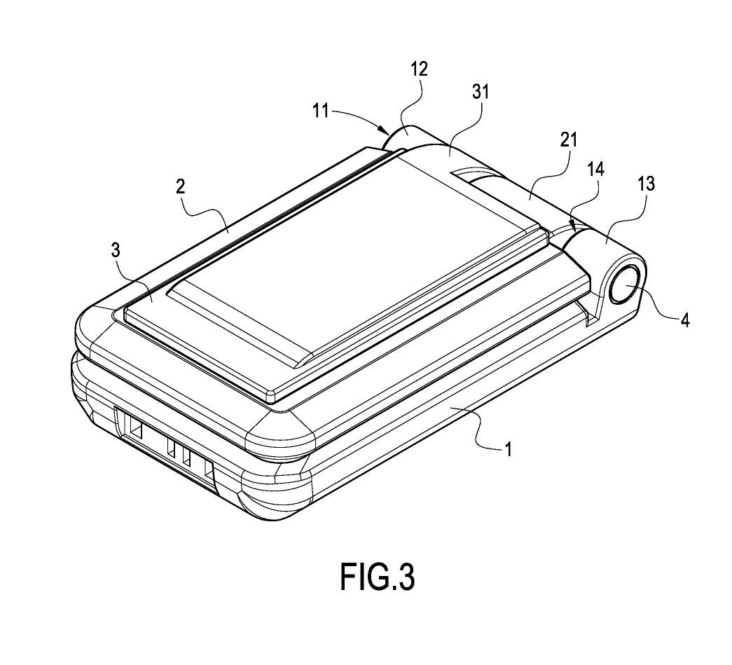

Referring to FIGS. 1 to 3 for a perspective view and a side view of a lifted open state and a schematic view of folded close sate of a communication apparatus with a solar energy charging function in accordance with the present invention respectively, the communication apparatus with a solar energy charging function of the invention comprises: a main system 1 of the communication apparatus, a display device 2, a solar panel 3 and an axle mechanism 4 to define a foldable mobile phone. The main system 1 has a hinge portion 11 disposed at an end of the main system 1, and the hinge portion 11 has two hinge ears 12, 13 disposed with an interval from each other in a hinge groove 14. The display device 2 and the solar panel 3 are coaxially coupled to the hinge portion 11 to operate in coordination with an axle mechanism 4 (which is a prior art structure, and thus will not be described here), and the display device 2 and the solar panel 3 are electrically coupled to a control circuit (not shown in the figure) installed in the main system 1. When the solar panel 3 is folded, the solar panel is covered onto a distal surface of the display device 2 without increasing the volume of the mobile phone or lifted open for the use for communications, or the solar panel 3 is lifted open for charging the battery (not shown in the figure) of the mobile phone to constitute a communication apparatus structure having a solar panel, so as to facilitate users to charge the battery of a mobile phone by using the solar panel 3.

The display device 2 has a first pivotal shaft 21 disposed at its end and pivotally coupled to a hinge portion 11 of the main system 1, and the axial width of the first pivotal shaft 21 is smaller than the width of a hinge groove 14 of the hinge portion 11. In other words, the display device 2 is pivotally coupled to the main system 1 by using the design of the first pivotal shaft 21, so as to pivotally connect the solar panel 3 by using a pivotal connecting space in the hinge groove 14.

The solar panel 3 has a second pivotal shaft 31 disposed at its end, and the axial width and position of the second pivotal shaft 31 are preferably corresponsive to the first pivotal shaft 21 of the display device 2 in the pivotal connecting space provided in the hinge groove 14. In other words, the sum of the axial width of the second pivotal shaft 31 of the solar panel 3 and the axial width of the first pivotal shaft 21 is preferably equal to or smaller than the width of the hinge groove 14 of the hinge portion 11, such that it is suitable for the second pivotal shaft 31 of the solar panel 3 and the first pivotal shaft 21 of the display device 2 to be coaxially and pivotally coupled in the hinge groove 14 and for the two hinge ears 12, 13 which are pivotally coupled to the main system 1 to produce the folding or lifting movements.

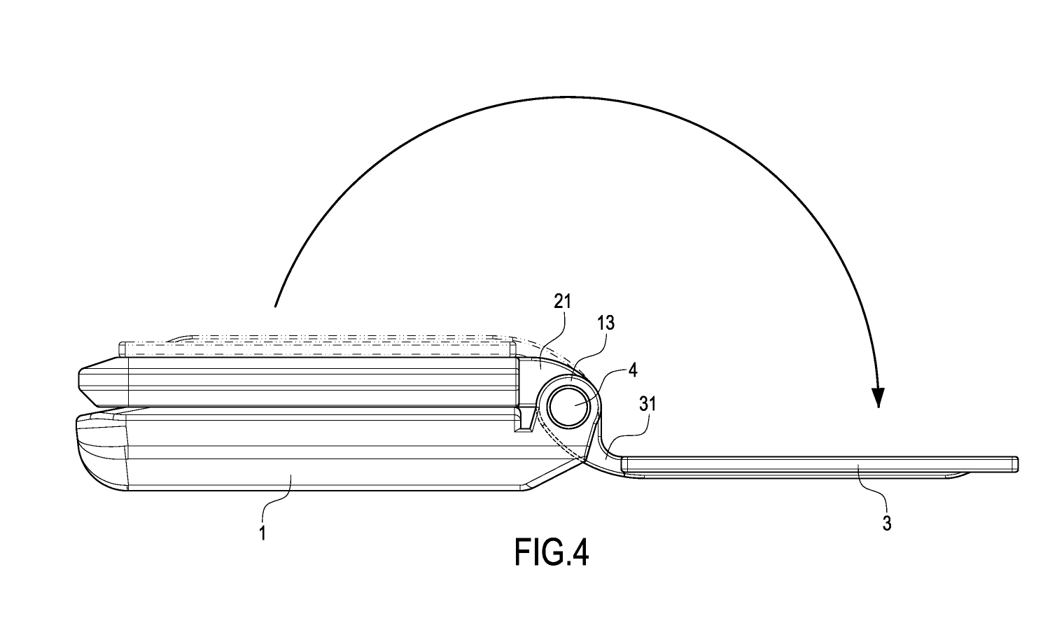

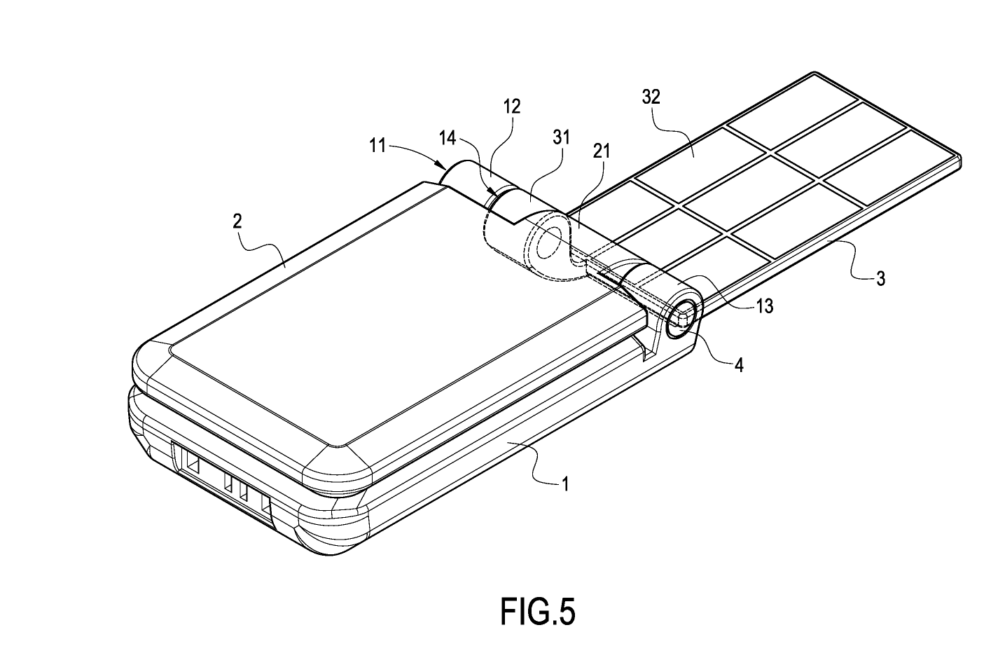

Referring to FIGS. 4 and 5 for a side view and a perspective view of a lifted open state for charging a communication apparatus with a solar energy charging function by solar energy, the communication apparatus with a solar energy charging function of the invention is assembled by the foregoing components. If the battery power of the mobile phone is low, then users can lift the solar panel 3 open from a distal surface of the display device 2 by the second pivotal shaft 31, and use a plurality of solar energy chips installed on a distal surface of the solar panel 3 to absorb solar energy. After the solar energy is converted into electric energy, the electric energy is used for charging a battery electrically connected to a mobile phone. After the battery is charged, the solar panel 3 is folded and covered onto a distal surface of the display device 2, and the battery charge of the battery by solar energy will be stopped.

Since the foregoing structure has the solar panel and the display device coaxially and pivotally coupled to the main system to integrate the solar panel with the communication apparatus, the solar panel can be lifted separately for charging the battery of the mobile phone battery, not only extending the using time of the communication apparatus, but also overcoming the problem of carrying a backup battery or a charger for changing or charging the battery without the need of increasing the overall volume or affecting the convenience for the carrying.

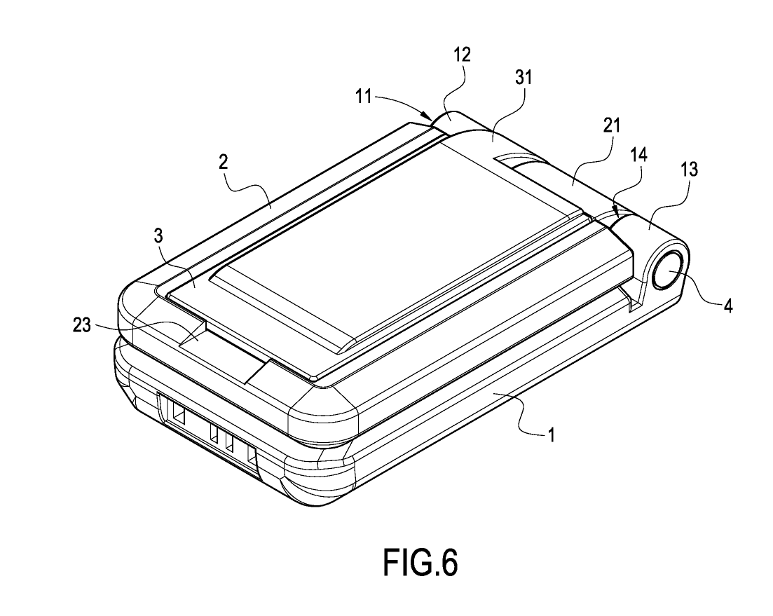

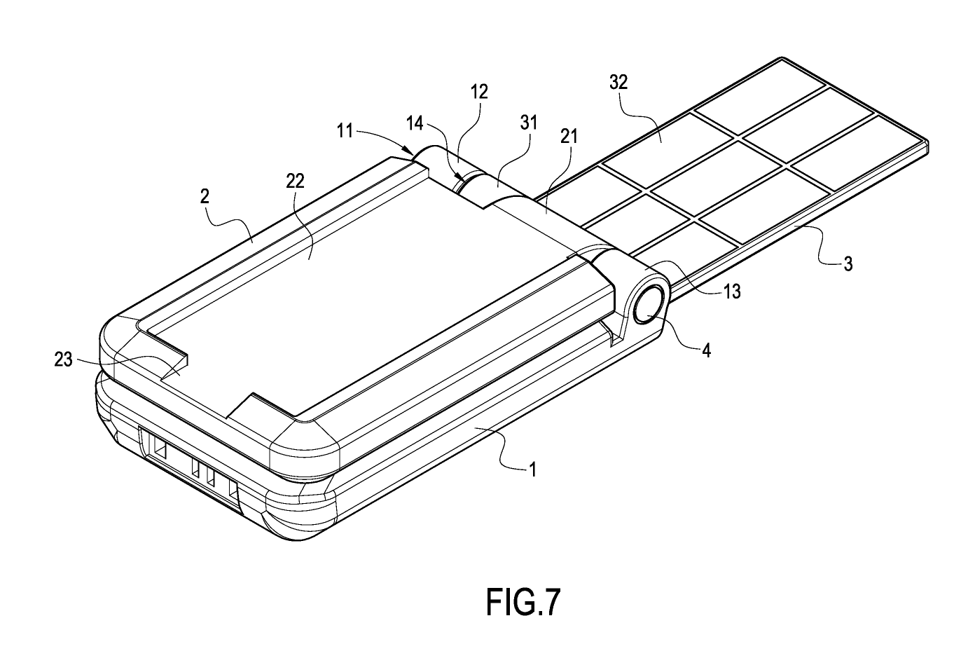

Referring to FIGS. 6 and 7 for schematic views of a lifted open state for charging a communication apparatus with a solar energy charging function in accordance with another preferred embodiment, this preferred embodiment is substantially the same as the embodiment illustrated in FIGS. 1 to 3, and the difference resides on that the display device 2 has a containing groove 22 corresponding to the solar panel 3 folded and covered onto a distal surface of the display device 2 for containing a folded solar panel 3 to fit a thin design with a small overall volume. Preferably, a breach 23 is set on a lateral side of the containing groove 22 to facilitate users to lift and accommodate the solar panel 3 into the containing groove 22 for charging the battery of the mobile phone.

According to the design, the height of the containing groove 22 is preferably smaller than, greater than, or equal to the thickness of the solar panel 3 to fit the overall thickness of the communication apparatus.

In summation of the above description, the invention herein enhances the performance than the conventional structure and further complies with the patent application requirements.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

1. A foldable mobile phone with a solar energy charging function, comprising:
a main system, having a hinge portion;
a display device, having a first shaft sleeve disposed at an end of the display device;
a solar panel, having a second shaft sleeve disposed at an end of the solar panel; and
an axle mechanism,
wherein the solar panel and the display device are coaxially coupled to the axle mechanism by the second shaft sleeve and the first shaft sleeve, respectively, together with the axle mechanism coupled to the hinge portion, such that the display device can be folded and cover onto the main system, and the solar panel can be folded and covered onto a distal surface of the display device and lifted synchronously with the display device for use of communications and the solar panel can be lifted separately for charging a battery of the mobile phone.

2. The foldable mobile phone with a solar energy charging function of claim 1, wherein the hinge portion has two hinge ears disposed with an interval from each other in a hinge groove.

3. The foldable mobile phone with a solar energy charging function of claim 1, wherein the first shaft sleeve has an axial width smaller than the width of the hinge groove, and the hinge groove forms an adjacent pivotal connecting space therein.

4. The foldable mobile phone with a solar energy charging function of claim 3, wherein a sum of the axial width of the first shaft sleeve of the display device and an axial width of the second shaft sleeve of the solar panel is not greater than the width of the hinge groove.

5. The communication apparatus foldable mobile phone with a solar energy charging function of claim 1, wherein the display device has a containing groove disposed at a position corresponding to a distal surface covering the solar panel.

6. The foldable mobile phone with a solar energy charging function of claim 5, wherein the containing groove has a breach disposed on a lateral end of the containing groove for facilitating a separate lift of the solar panel.

7. The foldable mobile phone with a solar energy charging function of claim 2, wherein the display device has a containing groove disposed at a position corresponding to the distal surface for receiving the solar panel.

8. The foldable mobile phone with a solar energy charging function of claim 7, wherein the containing groove has a breach disposed on a lateral end of the containing groove for facilitating a separate lift of the solar panel.

9. A foldable mobile phone with a solar energy charging function, comprising:
a main system, having a hinge portion, and a key board on a surface of the main system;
a display device, having a display surface and a distal surface opposite to each other and a first shaft sleeve disposed at an end of the display device, the display device being coaxially coupled to the hinge portion by the first shaft sleeve, and the display surface facing to the key board when the display device foldably covering on the main system;
a solar panel, having a second shaft sleeve disposed at an end of the solar panel and an energy chip surface, the solar panel being coaxially coupled to the hinge portion by the second shaft sleeve, and the energy chip surface facing to the distal surface of the display device when the solar panel foldably covering on the display device; and
an axle mechanism coupled to the hinge portion,
wherein the solar panel and the display device movably and pivotally coupled to the axle mechanism, such that the solar panel can be folded and lifted synchronously with the display device for use of communications, and the solar panel can be lifted separately for using the energy chip surface to charge a battery of the mobile phone.

10. The foldable mobile phone with a solar energy charging function of claim 9, wherein the hinge portion has two hinge ears disposed with an interval from each other in a hinge groove.

11. The foldable mobile phone with a solar energy charging function of claim 10, wherein the display device has a containing groove disposed at a position corresponding to the distal surface for receiving the solar panel.

12. The foldable mobile phone with a solar energy charging function of claim 11, wherein the containing groove has a breach disposed on a lateral end of the containing groove for facilitating a separate lift of the solar panel.

13. The foldable mobile phone with a solar energy charging function of claim 9, wherein the first shaft sleeve has an axial width smaller than the width of the hinge groove, and the hinge groove forms an adjacent pivotal connecting space therein.

14. The foldable mobile phone with a solar energy charging function of claim 13, wherein a sum of the axial width of the first-shaft sleeve of the display device and an axial width of the second shaft sleeve of the solar panel is not greater than the width of the hinge groove.

15. The foldable mobile phone with a solar energy charging function of claim 9, wherein the display device has a containing groove disposed at a position corresponding to a distal surface covering the solar panel.

16. The foldable mobile phone with a solar energy charging function of claim 15, wherein the containing groove has a breach disposed on a lateral end of the containing groove for facilitating a separate lift of the solar panel.
